(19) United States
(12) Patent Application Publication
(10) Pub. No.: US 2008/0076874 A1
(43) Pub. Date: Mar. 27, 2008

(54) Graft copolymer and its blends

(76) Inventors: Abuzar Syed, Torrington, CT (US); Peter Frenkel, Danbury, CT (US)

Correspondence Address: Daniel Reitenbach;CHEMTURA CORPORATION, Benson Road, Middlebury, CT, 06749, US

(21) Appl. No.: 11/525,464

(22) Filed: Sep. 22, 2006

(51) Int. Cl. C08L 51/00

(52) U.S. Cl. 525/70

(57) ABSTRACT

A composition is disclosed that comprises:
(A) at least one polymer selected from the group consisting of polyolefins, polar polymers, and mixtures thereof; and
(B) a graft copolymer comprising a propylene polymer backbone having grafted thereon at least one monomer selected from the group consisting of alkyl(meth)acrylates and vinyl aromatic compounds, said graft copolymer having been prepared by a solid state grafting process comprising blending a solid propylene polymer with said monomer(s) in a reactor in the presence of a free radical-generating means and reacting the polymeric components at elevated temperature in the absence of solvent.

### BACKGROUND OF THE INVENTION

1. Field of the Invention

The present invention relates to the use of polyalkyl(meth)acrylates grafted onto a propylene polymer and the use of the grafts as compatibilizers and property improvers for polyolefins.

As employed herein, the term “(meth)acrylate” is intended to mean “acrylate or methacrylate.”

2. Description of Related Art

The blending of two or more polymers is a common approach for obtaining polymeric materials that incorporate properties of the raw materials and/or improve properties of the individual polymers.

Polypropylene (PP) is a low cost, easy to process and recycle, commodity polymer of low density and very good resistance to chemicals and moisture. However, it is devoid of any polarity and, hence, is unable to interact with polar polymers to produce compatible blends. Compatibilizing blends of PP with polar polymers could enable the production of advanced polymeric materials and possibly ease the recycling of post-consumer waste into usable polymeric articles.

Accordingly, a number of efforts have been made over the years to develop compatibilized blends such as polypropylene with polyvinyl chloride.

Jianzhi et al. recently reported (www.chemistrymag.org/cji/2005/073023nc.htm) that a PP-g-(St-co-MMA) graft copolymer (6%) was effective in compatibilizing a PP/PVC (20/80) blend. The compatibilizer was produced via a melting/grafting process. The compatibility was demonstrated by scanning electron microscope micrographs. However, the property improvement of the blend was not demonstrated.

Wenyi et al. (Polymeric Materials Science and Engineering, 3:57-60 (1992)) reported the morphology (by SEM) of a compatibilized PP/PVC blend using chlorinated polyethylene (CPE, 2-5%) as a compatibilizer. A clear phase inversion was observed at 5% CPE loading.

Chung et al (Macromolecules, 27:1313-1319 (1994)) reported the synthesis of PP-g-polycaprolactone (PP-g-PCl) via borane containing PP intermediate. At 10%, this graft copolymer was shown to compatibilize PP/PVC (70/30) blends as evident from optical microscopy.

The use of low molecular weight reactive compounds and crosslinking agents as compatibilizers for a blend containing PVC of high molecular weight and PP was studied by Changren et al. (Polymeric Materials Science and Engineering, 14(3): 122-125 (1998)). A noticeable improvement in tensile properties was demonstrated (15-30%).

Hou et al. (Polymeric Materials Science and Engineering, 18(3):141-144 (2002)) reported the use of PP-g-PMMA and PP-g-PSt-co-MMA produced via melt grafting as compatibilizers which improved the tensile strength of the blend by 15%.

Irish Patent IE 921580 to Galvez et al. discloses compositions based on vinyl chloride polymer and on polyolefin in the presence of an α-monoolefin terpolymer grafted with vinyl chloride. The compositions are said to have good rheological properties and to be suitable for use in injection molding.

U.S. Pat. No. 4,664,984 to Klosiewicz discloses graft copolymers of polypropylene containing 3 to 100% by weight based on the weight of the polypropylene backbone, preferably 3 to 30%, of an alkyl methacrylate moiety. These are said to be useful as adhesives for bonding polypropylene to chlorinated hydrocarbon polymers.

U.S. Pat. No. 4,767,817 to Lee discloses shaped articles, which are said to have excellent solvent resistance and resistance to fatty acids, that are formed from a thermoplastic polyblend of poly(vinyl chloride) (PVC), chlorinated polyethylene (CPE), polyolefin (PO), and a graft copolymer of a polyolefin (PO-G). The thermoplastic polyblend contains a PO and PO-G (PO/PO-G) as a first continuous single phase and PVC and CPE as the second and third dispersed phases. The relative amounts of the components are chosen so that there is, at most, an equal amount by weight of PO and PO-G, each of which may be present in an amount as high as 40 parts by weight when the PVC is present in an amount in the range from 40 to 70 parts, so as to provide a mechanically compatible polyblend without miscibility or chemical compatibility. Further, a glass fiber reinforced (GFR) polyblend of PVC/CPE/PO/PO-G having a HDT of at least 95° C. and sufficient thermoformability to form the desired article is said to have excellent notched impact strength. The high HDT is obtained only if both co-compatibilizers and glass fibers are present in the reinforced composite.

U.S. Pat. No. 5,140,074 to DeNicola Jr. et al. discloses a method of making graft copolymers of olefin polymers by contacting a particulate olefin polymer with a free radical polymerization initiator, e.g., a peroxide, and a vinyl monomer at about from 600 to 125° C., while controlling the monomer addition rate so that it does not exceed about 4.5 pph/min, and most preferably does not exceed about 3.0 pph/min, at any monomer feed level. To prevent polymer degradation, a non-oxidizing environment is maintained throughout the process, residual free radicals are deactivated, and unreacted initiator is decomposed, before the graft copolymer is exposed to air.

U.S. Pat. No. 5,229,456 to Ilenda et al. discloses a graft copolymer that is said to be capable of imparting to a polyolefin when blended therewith high tensile modulus and high sag resistance without increasing melt viscosity, and a method of making the same. The graft copolymer is a polyolefin having a relatively high weight-average molecular weight methacrylate polymer grafted thereto. The graft copolymer is formed by dissolving or swelling a non-polar polyolefin in an inert hydrocarbon solvent, heating to dissolve the polyolefin, and while stirring the mixture, adding a methacrylate monomer, together with an initiator to produce a constant, low concentration of radicals, to form a graft copolymer with a high molecular weight polymer chain covalently bonded or grafted to the polyolefin backbone. The graft copolymer can be separated from the solvent, isolated by volatilizing the solvent, for example in a devolatilizing extruder, and extruded into a desired shape such as a sheet, tube or the like. This graft copolymer can be blended with a polyolefin matrix. The blend is said to exhibit improved physical properties in the melt, upon cooling, and in the solid state, and to be useful in cast and oriented films, solid extruded rod and profile, foamed rod, profile and sheet, blown bottles, and the like. The graft copolymer is also said to improve compatibility further in a wide range of polymer blends.

U.S. Pat. No. 5,411,994 to Galli et al. discloses graft copolymers of polyolefins and a method of preparing said graft copolymers. The method comprises irradiating a mass of olefin polymer particles and thereafter treating the mass of particles with a vinyl monomer in liquid form. A non-oxidizing environment is maintained throughout the process while free radicals produced in the olefin polymer by the irradiation are present, thereby preventing degradation of the polymer. In a final step, residual free radicals are deactivated, and any unreacted monomer is removed.

U.S. Pat. No. 6,417,260 to Weng et al. discloses compositions of a plasticized polyvinyl chloride resin, a polyolefin and/or a styrenic polymer, and a compatibilizer. The compositions are said to retain the mechanical properties of tensile strength, elongation, and a low brittle point, even after being subjected to high heat for an extended period of time.

The disclosures of the foregoing are incorporated herein by reference in their entirety.

Notwithstanding the above, there remains a need for an efficient compatibilizer for polyolefins, e.g., polypropylene, with polar polymers, such as PVC or PMMA, that could help improve mechanical properties, such as tensile strength, modulus, HDT, and elongation, particularly in injection molding applications.

### SUMMARY OF THE INVENTION

This invention relates to polymeric compositions comprising a polyalkyl (meth)acrylate grafted onto a propylene polymer backbone, wherein said graft is prepared by a solid state grafting process whereby high grafting efficiencies are obtained. As employed herein, the terminology polyalkyl(meth)acrylate is intended to mean polyalkyl acrylate or polyalkyl methacrylate. Polyalkyl methacrylates are preferred for use in the present invention.

The grafted copolymers comprising polyalkyl(meth)acrylates of the present invention are useful as compatibilizers for blends of polyolefins and polar polymers. Preferred polyolefins include polyethylene and polypropylene; preferred polar polymers are PVC and polymethyl methacrylate (PMMA).

More particularly, the present invention is directed to a composition comprising:

(A) at least one polymer selected from the group consisting of polyolefins, polar polymers, and mixtures thereof, and

(B) a graft copolymer comprising a propylene polymer backbone having grafted thereon at least one monomer selected from the group consisting of alkyl(meth)acrylates and vinyl aromatic compounds, said graft copolymer having been prepared by a solid state grafting process comprising blending a solid propylene polymer with said monomer(s) in a reactor in the presence of a free radical-generating means and reacting the polymeric components at elevated temperature in the absence of solvent.

### DESCRIPTION OF THE PREFERRED EMBODIMENT(S)

As noted above, the present invention is directed to a composition comprising:

(A) at least one polymer selected from the group consisting of polyolefins, polar polymers, and mixtures thereof; and

(B) a graft copolymer comprising a propylene polymer backbone having grafted thereon at least one monomer selected from the group consisting of alkyl(meth)acrylates and vinyl aromatic compounds, said graft copolymer having been prepared by a solid state grafting process comprising blending a solid propylene polymer with said monomer(s) in a reactor in the presence of a free radical-generating means and reacting the polymeric components at elevated temperature in the absence of solvent.

The polyolefins employed in the compositions of the present invention are preferably homopolymers or copolymers of olefin monomers that correspond to the formula (CH₂CHR)ₙ, wherein

R is selected from the group consisting of hydrogen and optionally substituted hydrocarbon radicals comprising from 1 to 12 carbon atoms, e.g., methyl, ethyl, propyl, butyl, pentyl, hexyl, heptyl, octyl, nonyl, decyl, undecyl, dodecyl, isomers and mixtures of the foregoing, and the like; and

n denotes that number of (CH₂CHR) units necessary to result in a desired molecular weight of up to 1,000×10³. Examples of such polyolefins include, but are not limited to, ethylene, propylene, 1-butene, and 4-methyl-1 pentene, and the like homo- and copolymers. Among these polyolefins, polyethylene and polypropylene homopolymers and copolymers are preferred. Most preferred are propylene homopolymers having melt indices of at least 1 dg/min, preferably from about 4 to about 100 dg/min (230° C., 2.16 kg).

The polar polymer of the present invention is preferably PVC or a polyalkyl methacrylate wherein the alkyl group is preferably one having from one to eight carbon atoms, which may be straight chain or branched, e.g., PMMA.

The PVC used can be obtained via polymerization in bulk or in suspension, or in emulsion, or in micro suspension, or in suspended emulsion.

As employed herein, the term poly(vinyl chloride), or PVC, is intended to include both homopolymers and copolymers of vinyl chloride, i.e., vinyl resins containing vinyl chloride units in their structure, e.g., copolymers of vinyl chloride and vinyl esters of aliphatic acids, in particular vinyl acetate; copolymers of vinyl chloride with esters of acrylic and methacrylic acid and with acrylonitrile; copolymers of vinyl chloride with diene compounds and unsaturated dicarboxylic acids or anhydrides thereof, such as copolymers of vinyl chloride with diethyl maleate, diethyl fumarate or maleic anhydride; post-chlorinated polymers and copolymers of vinyl chloride; copolymers of vinyl chloride and vinylidene chloride with unsaturated aldehydes, ketones and others, such as acrolein, crotonaldehyde, vinyl methyl ketone, vinyl methyl ether, vinyl isobutyl ether, and the like.

The term “PVC” as employed herein is also intended to include graft polymers of PVC with EVA, ABS, and MBS. Preferred substrates are also mixtures of the above-mentioned homopolymers and copolymers, in particular vinyl chloride homopolymers, with other thermoplastic and/or elastomeric polymers, in particular blends with ABS, MBS, NBR, SAN, EVA, CPE, MBAS, PMA, PMMA, EPDM, and polylactones.

Vinyl acetate, vinylidene dichloride, acrylonitrile, chlorofluoroethylene and/or the esters of acrylic, fumaric, maleic and/or itaconic acids may be mentioned as preferred examples of monomers that are copolymerizable with vinyl chloride. In addition, polyvinyl chloride can be chlorinated having chlorine content up to 70% by weight. This invention applies particularly to the vinyl chloride homopolymers.

Within the scope of this invention, PVC will also be understood to include recyclates of halogen-containing polymers, which are the polymers described above in more detail and which have suffered damage by processing, use, or storage. PVC recyclate is particularly preferred. The recyclates may also contain minor amounts of foreign materials, typically paper, pigments, adhesives or other polymers, which are often difficult to remove. These foreign materials can also originate from contact with different substances during use or working up, for example fuel residues, paint components, metal traces, initiator residues, and water traces.

The propylene polymer material used as a backbone of the graft copolymers is preferably:

(1) A homopolymer of propylene having isotactic index greater than 80, preferably about 85-99%. In place of propylene homopolymer, high and low density polyethylenes can also be employed.

(2) A copolymer of propylene and an olefin selected from the group consisting of ethylene and α-olefins of from four to ten carbon atoms, e.g., butene, pentene, hexene, heptene, octene, nonene, decene, isomers and mixtures of the foregoing, and the like, provided that when the olefin is ethylene, the maximum polymerized ethylene content is about 10%, preferably about 4%, and when the olefin is a C₄₋₁₀ α-olefin, the maximum polymerized content is about 20% by weight, preferably about 16%, the copolymer having an isotactic index greater than 85.

(3) A terpolymer of propylene and two olefins selected from the group consisting of ethylene and α-olefins of from four to eight carbon atoms, provided that the maximum polymerized C₄₋₈ α-olefin content is 20% by weight, preferably about 16%, and, when ethylene is one of the olefins, the maximum polymerized ethylene content is 5% by weight, preferably about 4%, the terpolymer having an isotactic index greater than 85.

Propylene homopolymer is the preferred propylene polymer backbone material.

The monomers that can be grafted onto the backbone of propylene polymer material are selected from the group consisting of unsaturated carboxylic acid esters, vinyl aromatic compounds, and mixtures thereof. During the graft polymerization, the monomers also copolymerize to form a certain amount of free or ungrafted copolymer or terpolymer. The polymerized monomers comprise about 1 to about 100 parts per hundred of the propylene polymer material, preferably about 30 to about 95 pph. The morphology of the graft copolymer is such that the propylene polymer material is the continuous or matrix phase, and the polymerized monomers, both grafted and ungrafted, are a dispersed phase.

The vinyl aromatic compounds can be substituted or unsubstituted and include, for example, styrene, α-methylstyrene, 4-butylstyrene, 4-tert-butylstyrene, 2-ethylstyrene, 2-methoxystyrene, 4-methoxystyrene, vinylnaphthalene, or any halogenated styrene such as 2-chlorostyrene and 4-chlorostyrene.

Suitable unsaturated carboxylic acid/esters include, for example, acrylic acid and alkyl acrylate esters, methacrylic acid/esters. The alkyl groups of such esters preferably comprise from one to eight carbon atoms, which can be straight chain or branched, e.g., methyl acrylate, ethyl acrylate, propyl acrylate, butyl acrylate, pentyl acrylate, hexyl acrylate, heptyl acrylate, octyl acrylate, methyl methacrylate, ethyl methacrylate, propyl methacrylate, butyl methacrylate, pentyl methacrylate, hexyl methacrylate, heptyl methacrylate, octyl methacrylate, and isomers of the foregoing. Preferred monomers include butyl methacrylate, methyl methacrylate, styrene, and α-methylstyrene. In the case of styrene/alkyl methacrylates, the methyl and butyl methacrylates comprise about 10% to about 90%, preferably about 10% to about 50% of the total weight of the monomers.

### Preparation of Graft Copolymers

The grafted copolymer chains act as a compatibilizer for the polypropylene and the polyvinyl chloride phases. The graft copolymers are made by a solid state grafting process wherein active grafting sites are formed on the propylene polymer material by treating it with organic peroxide or other chemical compound that is a free radical polymerization initiator, or by irradiation with gamma (high energy) ionizing radiation. The free radicals produced on the polymer as a result of the chemical or irradiation treatments form the active grafting sites on the polymer and initiate the polymerization of the monomers at these sites. Graft copolymers produced by peroxide-initiated grafting methods are preferred.

The preparation of graft copolymers by contacting polypropylene with a free radical polymerization initiator, such as organic peroxide, and at least one vinyl monomer is described in more detail in U.S. Pat. Nos. 4,664,984 and 5,140,074, which are incorporated herein by reference.

The preparation of graft copolymers by irradiating an olefin polymer and then treating with at least one vinyl monomer is described in more detail in U.S. Pat. No. 5,411,994, which is incorporated herein by reference.

The key requirements of a suitable compatibilizer are that the grafting monomer should be attached to the PP with high grafting efficiency, e.g., 30% or greater, and have appropriate chain lengths sufficient to mix with the polar polymer, e.g., PVC.

The compatibilizer of this invention (the alkyl(meth)acrylate grafted-PP-co- and terpolymer) is preferably produced in a reactor using organic peroxide via a solid state grafting process at temperatures of 110°-140° C., which permits better control of the grafting efficiency and the molecular weight of the (meth)acrylate chain, as compared to grafting in melt phase. In melt phase grafting, the reaction temperature is high. The half-life of the peroxide, for the grafting reaction to occur, is very short at that temperature, and PP degradation becomes a major reaction path rather than grafting.

The composition of the graft copolymer designated as PP-g-PMMA used in this invention is approximately 40% PP, 40% PMMA, and 20% PP-g-PMMA. The PP-g-PBMA graft copolymer used has 5-25% PBMA (polybutyl methacrylate) grafted onto PP. The homopolymer polymethyl methacrylate used in the examples below was Plexiglas, Grade V920-100 (MFR 8 dg/min at 230° C., 3.8 kg).

### Composition of Binary Blends

In the binary blends comprising the graft copolymers and PVC, PMMA, or other polar (co)polymers, the concentration of the graft copolymers varied from 1 to 99% but was preferably about 50%.

### Compositions of Tri-Component Polymeric Systems

The amount of the binary blends in the polymeric compositions with PP was varied from 1 to 50%, preferably 10-20%. Accordingly, the preferred amount of PP in the system was 80-90%.

In addition to the three components, which are preferably PVC or PMMA; polyolefins such as PP; and the graft polymers, the blend may optionally contain small quantities of polymer additives. Depending on their end use requirement, the compositions employed in the practice of the present invention can also contain, inter alia, process aids, fusion promoters, plasticizers, lubricants, waxes, impact modifiers, fillers, reinforcing agents, antioxidants, light stabilisers, UV absorbers, blowing agents, fluorescent whitening agents, pigments, flame retardants, antistatic agents, gelling assistants, metal deactivators, scavenging compounds, modifiers and further sequestrants for Lewis acids, and the like, as is known in the art. See, for example, U.S. Pat. No. 6,531,533 to Kuhn et al., the disclosure of which is incorporated herein by reference in its entirety. Preferred additives are selected from the group consisting of heat stabilizers, lubricants, impact modifiers, processing aids, antioxidants, mold release agents, fusion promoters, metal release agents, co-stabilizers, fillers, pigments, UV absorbers, antistatic agents, and plasticizers.

Where fusion promoters, process aids, and lubricants are included in the compositions of the present invention, they can be, but are not limited to, for example, calcium stearate, such as heat and UV stabilizers, antistatic agents, lubricants, plasticizers, impact modifiers, process aids, and others.

Various features and aspects of the present invention are illustrated further in the examples that follow. While these examples are presented to show one skilled in the art how to operate within the scope of the invention, they are not intended in any way to serve as a limitation upon the scope of the invention.

### EXAMPLES

### Dry Blend Preparation and Compression Molding Process

All the ingredients employed in the following examples were in a solid form and, therefore, were dry blended at room temperature.

For example, the binary blend containing the appropriate amounts of a standard rigid PVC compound (containing appropriate amounts of lubricants, heat stabilizers, process aids and impact modifiers) and PP-g-PBMA was pre-mixed for 15 minutes, then placed on two-roll mill heated to 170° C. When the compound is banded on the roll, the PP pellets were added while continuing to mix on the mill to achieve homogeneity. The mill time was about five minutes. The molding process had the following profile.

Step 1: 177° C. and 5,000 psi for four minutes after the temperature is stabilized;

Step 2: Maintaining 177° C., the force was increased to 20,000 psi for three minutes;

Step 3: The temperature was reduced to 49° C., maintaining the same force.

Articles of manufacture can be formed from the components of this invention by methods known in the art including, for example, injection molding, compression molding, sheet extrusion, thermoforming, profile extrusion, and the like.

The test methods used to evaluate the molded specimens were:
Tensile strength at yield (psi): ASTM D-638@2″/min.
Tensile modulus at yield (kpsi): ASTM D-638@2″/min.
Elongation to break (%): ASTM D-638@2″/min.
Heat deflection temperature (° C.): ASTM D-648

TABLE 1
Synergistic Effect of the Graft Copolymer/PVC Binary Blend
on Tensile Properties and HDT of Polypropylene

| Blends/Characteristics | Peak Stress (psi) | Modulus (psi) | HDT (° C.) |
|---|---|---|---|
| PP (Control) | 4511 | 324647 | 75 |
| PP/PVC | 4371 | 319295 | 77 |
| (95/5, control) | | | |
| PP/PP-g-PBMA | 5028 | 326542 | 76 |
| (95/5, control) | | | |
| PP/PVC/PP-g- | 5674 | 396267 | 79 |
| PBMA* (90/5/5) | | | |

*Note: MFR of the PP-g-PBMA sample used in this series was 42 dg/min.

TABLE 2
Synergistic Effect of the Graft Copolymer/PMMA Binary Blend
on Tensile Properties and HDT of Polypropylene

| Blends/Characteristics | Peak Stress (psi) | Modulus (psi) | HDT (° C.) |
|---|---|---|---|
| PP (Control) | 4511 | 324647 | 75 |
| PP/PMMA | 5151 | 332734 | 78 |
| (90/10, control) | | | |
| PP/PP-g-PBMA | 5028 | 326542 | 76 |
| (95/5, control) | | | |
| PP/PMMA/PP-g- | 5758 | 339783 | 81 |
| PBMA* (90/5/5) | | | |

*Note: MFR of the PP-g-PBMA sample used in this series was 42 dg/min.

TABLE 3
Effect of the Binary Blend** Loading on HDT of PVC

| Loading (%) | HDT (° C.) |
|---|---|
| 0 | 69.6 |
| 20 | 72.5 |
| 30 | 75.4 |

**Note: The binary blend was composed of PP-g-PMMA and PVC.

TABLE 4
Effect of the Binary Blend** Loading on HDT of PP

| Loading (%) | HDT (° C.) |
|---|---|
| 0 | 75 |
| 10 | 80 |
| 20 | 83 |
| 40 | 85 |

**Note: The binary blend was composed of PP-g-PMMA and PP.

Various blends of PP/PVC (30/70%) with PP-g-PBMA of different MFR (10-150 dg/min @2.16 kg, 230° C.) were compression molded into test specimens and the properties were tested. The control sample contained PVC (70%) resin and PP homopolymer (30%) of 4 MFR. The compositions according to this invention exhibit a good compatibility and improved properties (Table 5) as compared to the control.

TABLE 5
Effect of MFR of the PP-g-PBMA Compatibilizer on Tensile
Strength (Peak Stress) and Elongation (Strain at Break)
of the PVC-Enriched Blends

| | Compatibilizer MFR | | |
|---|---|---|---|
| Blends*/ | (230° C., 2.16 kg) | Peak Stress (Tensile | Strain at |
| Characteristics | dg/min. | Strength) (psi) | Break (%) |
| PVC/PP (Control) | — | 3851 | 1.70 |
| PVC/PP/PP-g- | 8 | 4924 | 2.17 |
| PBMA | | | |
| PVC/PP/PP-g- | 24 | 4913 | 2.59 |
| PBMA | | | |
| PVC/PP/PP-g- | 42 | 5929 | 3.28 |
| PBMA | | | |
| PVC/PP/PP-g- | 71 | 4803 | 2.19 |
| PBMA | | | |
| PVC/PP/PP-g- | 141 | 4935 | 2.16 |
| PBMA | | | |

*Note: the control contained 70% PVC and 30% PP. All other blends contained 70% PVC, 25% PP and 5% PP-g-PBMA (M_{w} = 20,000–56,000).

PP-g-PBMA graft copolymers added at 5% to the PP/PVC blends functioned as compatibilizers improved mechanical properties, such as tensile strengths (up to 54%) and elongation (27-93%) as compared to the properties of the PP/PVC control without the graft copolymer.

The graft copolymer disclosed in U.S. Pat. No. 5,229,456, which is used as a property modifier and as a compatibilizer for incompatible polymer blends, was produced via a solution process. The graft copolymers of the present invention are produced via a solid state grafting process. In solid state grafting processes, the reaction is carried out in the solid phase and hence does not require any purification step at the end of the reaction. The solution process is a long and tedious process utilizing a purification (solvent de-volatilization) step at the end, either by evaporation or in an extruder. Further, it produces a material that is compositionally and structurally different from the material of the present invention. The difference in the structure of the graft polymer of the present invention makes it a better compatibilizer as evidenced by the improvement in tensile property of the blends.

An ideal compatibilizer for a polar polymer, such as PMMA and PVC, and a non-polar polymer, such as PP, should be a graft copolymer of a polar polymer onto PP having a very high grafting efficiency. Often, the grafting process, whether solid state, melt, or solution, results in a graft copolymer having ungrafted PP, grafted PP, and free polar polymers. To have an effective compatibilizer, it is desirable that the presence of free polar polymer (not attached onto PP chain) be minimized. This free polar polymer present in the graft copolymer does not really contribute to the compatibilizing properties of the material at all.

The graft copolymers obtained from solution process in U.S. Pat. No. 5,229,456 have a low level of grafted portion (10.6-29.8%) and high level of ungrafted acrylic copolymers (see Table 3, column 18, of the patent). As can be seen in Table 6 below, the graft copolymer of the present invention has a much higher content of the graft-polymer.

TABLE 6
Characterization of PP-g-PBMA Graft Copolymer of Present Invention

| | MFR (230° C., 2.16 Kg) | | | | |
|---|---|---|---|---|---|
| | 8 | 24 | 42 | 71 | 141 |
| M_{w} | 56372 | 86756 | 33722 | 47209 | 21544 |
| Mₙ | 12686 | 18666 | 12108 | 8560 | 6631 |
| M_{w}/Mₙ | 4.44 | 4.65 | 2.8 | 5.51 | 3.25 |
| Total PBMA | 16.6 | 13 | 13 | 14 | 14.3 |
| in PP (%) | | | | | |
| Grafting | 82 | 70 | 75 | 79 | 79 |
| Efficiency | | | | | |
| (%) | | | | | |

As a result, when the graft copolymer of U.S. Pat. No. 5,229,456 was used at 5% in PP/PVC (70/30, 45/55, and 20/80%) blends, the tensile strength improvements were only 4, 7, and 30% whereas there is an improvement of 25-54% in tensile strengths from the graft copolymers of the present invention that were added at the same loading. Similarly, an improvement of 27-93% in tensile elongation to break properties has been observed when the instant graft copolymers are employed. These are indications of more effective compatibilization.

Further, the synergistic effects of our compatibilizers with the PVC in PP have been demonstrated. The PP-g-PBMA graft copolymer (5%) having an MFR of 42 dg/min., when used in conjunction with PVC (5%) in PP homopolymer, improves the tensile strength and modulus of PP by 30% and 24% over PP/PVC (95/5%) (see Table 1).

Similarly, the tensile strength of PP improved by 28% and the HDT by 6° C. owing to a synergistic effect of 5% each of PMMA and PP-g-PBMA (MFR 42 dg/min) in PP (see Table 2). Neither of the additives could do that alone. Additionally, the graft copolymer of the present invention is a HDT improver for PVC (see Tables 3 and 4).

In view of the many changes and modifications that can be made without departing from principles underlying the invention, reference should be made to the appended claims for an understanding of the scope of the protection to be afforded the invention.

What is claimed is:

1. A composition comprising:
(A) at least one polymer selected from the group consisting of polyolefins, polar polymers, and mixtures thereof; and
(B) a graft copolymer comprising a propylene polymer backbone having grafted thereon at least one monomer selected from the group consisting of alkyl(meth)acrylates and vinyl aromatic compounds, said graft copolymer having been prepared by a solid state grafting process comprising blending a solid propylene polymer with said monomer(s) in a reactor in the presence of a free radical-generating means and reacting the polymeric components at elevated temperature in the absence of solvent.

2. The composition of claim 1 wherein the alkyl(meth)acrylate is an alkyl methacrylate.

3. The composition of claim 2 wherein the polyolefin is selected from the group consisting of homopolymers and copolymers of olefin monomers that correspond to the formula (CH₂CHR)ₙ, wherein
R is selected from the group consisting of hydrogen and optionally substituted hydrocarbon radicals comprising from 1 to 12 carbon atoms; and
n denotes that number of (CH₂CHR) units necessary to result in a desired molecular weight of up to 1,000×10³.

4. The composition of claim 3 wherein the polyolefin is a propylene homopolymer having a melt index of at least 1 dg/min.

5. The composition of claim 2 wherein the polar polymer is PVC or a polyalkyl methacrylate.

6. The composition of claim 5 wherein the polyalkyl methacrylate is polymethyl methacrylate.

7. The composition of claim 5 wherein the PVC is a vinyl chloride homopolymer.

8. The composition of claim 2 wherein the propylene polymer backbone is selected from the group consisting of:
(1) a homopolymer of propylene having an isotactic index greater than 80;
(2) a copolymer of propylene and an olefin selected from the group consisting of ethylene and α-olefins of from four to ten carbon atoms, provided that when the olefin is ethylene, the maximum polymerized ethylene content is about 10% by weight, and when the olefin is a C₄₋₁₀ α-olefin, the maximum polymerized content is about 20% by weight, wherein the copolymer has an isotactic index greater than 85; and
(3) a terpolymer of propylene and two olefins selected from the group consisting of ethylene and α-olefins of from four to eight carbon atoms, provided that the maximum polymerized C₄₋₈ α-olefin content is 20% by weight, and, when ethylene is one of the olefins, the maximum polymerized ethylene content is 5% by weight,
wherein the terpolymer has an isotactic index greater than 85.

9. The composition of claim 8 wherein the propylene polymer backbone is propylene homopolymer.

10. The composition of claim 1 wherein the at least one grafted monomer is selected from the group consisting of styrene, α-methylstyrene, 4-butylstyrene, 4-tert-butylstyrene, 2-ethylstyrene, 2-methoxystyrene, 4-methoxystyrene, vinylnaphthalene, 2-chlorostyrene, 4-chlorostyrene, methyl acrylate, ethyl acrylate, propyl acrylate, butyl acrylate, pentyl acrylate, hexyl acrylate, heptyl acrylate, octyl acrylate, methyl methacrylate, ethyl methacrylate, propyl methacrylate, butyl methacrylate, pentyl methacrylate, hexyl methacrylate, heptyl methacrylate, octyl methacrylate, and isomers of the foregoing.

11. The composition of claim 10 wherein the at least one grafted monomer is selected from the group consisting of butyl methacrylate, methyl methacrylate, styrene, and α-methylstyrene.

12. The composition of claim 1 wherein the free-radical generating means is a free radical polymerization initiator or irradiation with gamma ionizing radiation.

13. The composition of claim 12 wherein the free-radical generating means is an organic peroxide.

14. A composition comprising:
(A) at least one polymer selected from the group consisting of a polypropylene homopolymer and a polar polymer selected from the group consisting of PVC, PMMA and mixtures of the foregoing; and
(B) a graft copolymer comprising a propylene homopolymer backbone having grafted thereon at least one monomer selected from the group consisting of methyl methacrylate and butyl methacrylate, said graft copolymer having been prepared by a solid state grafting process comprising blending solid propylene homopolymer with said monomer(s) in a reactor in the presence of an organic peroxide and reacting the polymeric components at a temperature in the range of from about 110° to about 140° C. in the absence of solvent.

15. The composition of claim 14 wherein the polar polymer is a vinyl chloride homopolymer.

16. The composition of claim 14 wherein the polar polymer is polymethyl methacrylate.

17. The composition of claim 15 wherein the grafted monomer is butyl methacrylate.

18. The composition of claim 16 wherein the grafted monomer is butyl methacrylate.
